(19) United States
(12) Patent Application Publication
(10) Pub. No.: US 2014/0280729 A1
(43) Pub. Date: Sep. 18, 2014

(54) SYSTEM & METHOD FOR TRANSMISSION & DISPLAY ON NETWORK NODES

(71) Applicants: Alan C. THOMAS, Kansas City, MO (US); Chris RIEBSCHLAGER, Kansas City, MO (US); Mark D. LOGAN, Prairie Village, KS (US); Sara Grier BUCK, Kansas City, MO (US); John W. TENJACK, III, Kansas City, MO (US); Chelsie M. FRENCH, Overland Park, KS (US); Kathreen HORNADAY, Parkville, MO (US); David SEBELA, Stockholm (SE)

(72) Inventors: Alan C. THOMAS, Kansas City, MO (US); Chris RIEBSCHLAGER, Kansas City, MO (US); Mark D. LOGAN, Prairie Village, KS (US); Sara Grier BUCK, Kansas City, MO (US); John W. TENJACK, III, Kansas City, MO (US); Chelsie M. FRENCH, Overland Park, KS (US); Kathreen HORNADAY, Parkville, MO (US); David SEBELA, Stockholm (SE)

(21) Appl. No.: 14/213,517

(22) Filed: Mar. 14, 2014

Related U.S. Application Data
(60) Provisional application No. 61/783,629, filed on Mar. 14, 2013.

(51) Int. Cl. H04L 29/08

(52) U.S. Cl. CPC H04L 67/02
USPC 709/217

(57) ABSTRACT

A presenter delivering a presentation to an audience member uses the disclosed systems and methods to create an immersive delivery of presentation elements by synchronizing components, visual elements, and digital interactions of the presentation to mobile devices. The audience member may hold a mobile device in his hand that receives presentation content and interactions in real-time, and may hold a mobile display device that presents visual content to aid the oral delivery of the presentation.

### CROSS-REFERENCE TO RELATED APPLICATION

This application claims the benefit of U.S. Provisional Application No. 61/783,629, filed Mar. 14, 2013, the contents of which are incorporated herein by reference.

### BACKGROUND

The present invention relates generally to a system and method for transmission and display on network nodes, and more particularly to a system and method for transmission, receipt, display, interaction, synchronization, interaction, and presentation of content to a user and for simulating functions of a network node.

Presenters communicate information regarding topics of interest to their audience, through a variety of methods, with varying degrees of efficiency and effectiveness depending on both the presenter and the presentation method. The information may be communicated via a presentation to the audience in a traditional classroom or theater setting, with a whiteboard or PowerPoint presentation, or via a presentation by a device capable of presenting the information, such as a computer, laptop, netbook, tablet computer, smartphone, or other mobile device, etc. The communicated information may provide background information about the topic, and may include other aspects of the topic. Where the topic is related to the usage of a device—for example, using an application on a mobile device—the background information may include features, functions, specifications, usage, operations, instructions, and maintenance of the application and/or the device. Audience members then apply the information learned from the presentation in order to use, operate, implement, or interact with the application and/or device.

When the audience members' apply the learned information to operate the application and/or device, they must make the connection between the information and the operation of the application and/or the device. Audience members must take what they have learned, and translate it to relevant device functionalities without the benefit of experiencing how the application and/or device would function at the time the information is being presented. The device's functionalities are not simulated for the audience members at the time that information immediately relevant to a given functionality is being communicated to the audience members.

### SUMMARY

According to one aspect, a system is provided for transmission on network nodes, the system comprising a network and a plurality of network nodes, each node being connected to the network, wherein at least one node is configured to cause information to be transmitted to at least one other node via the network, and the at least one other node is configured to receive the information via the network. The at least one node comprises at least one control node, and the at least one other node comprises at least one audience node. The at least one audience node comprises at least one mobile device. In some embodiments, the control node comprises at least one mobile device. The mobile devices may be selected from a group consisting of a tablet computer, a smartphone, and a mobile computer. In one aspect, the network is a wireless network, and the wireless network may comprise a wireless router.

According to an embodiment, the transmitted information comprises presentation content, and may further comprise interactive content. The subject matter of the both types of content includes the use of electronic devices to perform functions selected from the group comprising: determining inventory levels; performing point-of-sale operations; clocking employees in and out; collecting patient information; recording services and medicines provided; recording a health provider's notes; taking food orders; transmitting food orders; recording a vehicle's information, recording defects and damage to a vehicle; performing vehicle diagnosis, and identifying needed repairs and parts.

In some embodiments, the at least one control node transmits the information. In other embodiments, the system further comprises a broadcast server configured to transmit the information. In one embodiment, the broadcast server is configured to receive other information from the at least one control node. Based on the other information, the broadcast server may transmit the information to the at least one other audience node via the network. In another embodiment, the network comprises a broadcast server, and the at least one node is configured to transmit the information to the broadcast server, and the broadcast server is configured to transmit the information, in turn, to the at least one other node.

According to an embodiment, a second audience node is provided, and the at least one control node is further configured to cause at least part of the information to be transmitted to the first audience node and the second audience node. The information or portion thereof sent to the first audience node may be the same as or different from that sent to the second audience node. In one embodiment, the first audience node is configured to receive the transmitted information and to present content based on the received information, and the second audience node is configured to receive the transmitted information and to perform an interaction based on the received information. In some cases, an audience node is selected from a group comprising a computer, a desktop computer, a thin client, a server computer, a presentation device, a display device, a gaming device, a networked device, a mobile phone, a mobile computer, a smart phone, a tablet computer, a laptop, a netbook, a personal digital assistant, and a mobile device having a processor and a memory.

In some cases, the second audience node is configured to activate or deactivate a feature or function of the second audience node. In an embodiment, the second audience node is configured to simulate the day-to-day functionality of the second audience node. The simulated functionality comprises at least one of: the audience node ringing, displaying the home screen of the audience node, and causing an SMS (Short Message Service) notification to appear.

In one embodiment, an audience member is associated with both the first audience node and the second audience node, so that each audience member is associated with a first audience node and a second audience node. In another embodiment, a plurality of audience members is associated with the first audience node and the second audience node, so that the plurality of audience members shares access to the first audience node and the second audience node.

In an embodiment of the system, the control node is selected from a group comprising a device with a processor, a mobile device, a cell phone, a smart phone, a mobile computer, a laptop, a networked device, a desktop computer, a server computer, a display device, or a presentation device. In some instances, the interaction performed by the second audience node is selected from a group comprising a vibration; a barcode scan; an NFC interaction; capturing an image, a video or a sound; or presenting an image, a video, or a sound.

In some embodiments, a system is provided for transmission on network nodes, the system comprising a network and a plurality of network nodes, each node being connected to the network, wherein at least one node comprises at least one control device configured to cause information to be transmitted to at least one other node via the network; the at least one other node comprises at least one audience device configured to receive the information via the network; and the transmitted information comprises presentation content. In an embodiment, the presentation content comprises interactive content. In one aspect, the information is transmitted and received in real-time. The information received by each of the plurality of network nodes may be synchronized, and may be further synchronized with the transmitted information.

According to some embodiments of the system, the plurality of network nodes further comprise a broadcast server, wherein the at least one control device transmits the information; the broadcast server is configured to receive the transmitted information; and the broadcast server is configured to transmit at least part of the information to the at least one audience device. The at least one audience device may be selected from a group comprising a computer, a desktop computer, a thin client, a server computer, a presentation device, a display device, a gaming device, a networked device, a mobile phone, a mobile computer, a smart phone, a tablet computer, a laptop, a netbook, a personal digital assistant, and a mobile device having a processor and a memory. In an embodiment, the system further comprises a wireless router, wherein the network comprises a wireless network.

According to one embodiment of the system, the at least one audience device comprises a first audience device and a second audience device, and the at least one control device is further configured to cause at least part of the information to be transmitted to the first audience device and to the second audience device. The information or portion thereof sent to the first audience device may be the same as or different from that sent to the second audience device. In one embodiment, the first audience device is configured to receive the transmitted information and to present content based on the received information, and the second audience device is configured to receive the transmitted information and to perform an interaction based on the received information.

In some embodiments, the control device is selected from a group comprising a device with a processor, a mobile device, a cell phone, a smart phone, a mobile computer, a laptop, a networked device, a desktop computer, a server computer, a display device, or a presentation device. According to an embodiment, the interaction may be selected from a group consisting of a vibration; a barcode scan; an NFC interaction; capturing an image, a video or a sound; or presenting an image, a video, or a sound. In one embodiment, each audience device is selected from a group consisting of a computer, a desktop computer, a thin client, a server computer, a presentation device, a display device, a gaming device, a networked device, a mobile phone, a mobile computer, a smart phone, a tablet computer, a laptop, a netbook, a personal digital assistant, and a mobile device having a processor and a memory.

According to one embodiment, the second audience device is configured to activate or deactivate a feature or function of the second audience device. In some embodiments, the second audience device is configured to simulate the day-to-day functionality of the second audience device. The simulated functionality may comprise at least one of: the audience device ringing, displaying the home screen of the audience device, and causing an SMS notification to appear.

In some instances, one audience member is associated with both the first audience device and the second audience device, so that each audience member is associated with a first audience device and a second audience device. In other instances, a plurality of audience members is associated with the first audience device and the second audience device.

### BRIEF DESCRIPTION OF THE DRAWINGS

The drawings constitute a part of this specification and include exemplary embodiments of the disclosed subject matter and illustrate various objects and features thereof.

FIG. 1 is an embodiment of the disclosed subject matter.

FIG. 2 is an overview diagram of an embodiment of the disclosed subject matter.

FIG. 3 is a diagram illustrating aspects of the disclosed subject matter.

FIG. 4 is a diagram illustrating aspects of the disclosed subject matter.

FIG. 5 is a diagram illustrating aspects of the disclosed subject matter.

FIG. 6 is an example of an audience device and presentation content according to an embodiment of the disclosed subject matter.

FIG. 7 is an example of an audience device and interactive content according to an embodiment of the disclosed subject matter.

FIG. 8 is a flow chart illustrating aspects of transmission according to an embodiment of the disclosed subject matter.

FIG. 9 is a flow chart illustrating aspects of transmission according to an embodiment of the disclosed subject matter.

FIG. 10 is a flow chart illustrating aspects of transmission and presentation according to an embodiment of the disclosed subject matter.

FIG. 11 is a flow chart illustrating aspects of transmission and presentation according to an embodiment of the disclosed subject matter.

### DETAILED DESCRIPTION

It is desirable to create an immersive delivery of information regarding a system or a device, so that an audience member can, in addition to receiving such information, simultaneously experience simulated functionalities of the system or device that are relevant to the information being communicated to the user. Thus, a presenter communicates information regarding a system or device, or an application thereon, to an audience member, and causes the system or device to emit a sound, such as the system or device ringing, to display the home screen of the system or device, to present a SMS notification, etc. The information can be presented on the system or device or can be presented on another system or device.

In a broad aspect, a presenter delivering a presentation to an audience member uses the disclosed systems and methods to create an immersive delivery of presentation elements by synchronizing components, visual elements, and digital interactions of the presentation to mobile devices. FIG. 1 is an illustration of one embodiment of the system. The audience members may hold mobile devices 100, 101, 102 in hand and receive presentation content and interactions in real-time, and may hold mobile display devices 110, 111, 112 that present visual and audio content to aid the oral delivery of the presentation. FIG. 2 is an overview diagram of an embodiment of the system.

In various fields, an electronic device is commonly used to facilitate one or more tasks. In the retail field for example, electronic devices, such as cell phones, smartphones, tablets, laptops, and other computers, may be used to determine, save, and transmit inventory levels, perform point-of-sale operations, and to clock employees in and out. Such electronic devices may be used at a healthcare facility to collect patient information, record services and medicines provided, and record the notes of a doctor or other provider. In a restaurant scenario, the electronic devices may be used to take and transmit orders. Such electronic devices may be used in vehicle repair, for example, to record a vehicle's information, defects, and damage, perform vehicle diagnosis, and identify needed repairs and parts. In some circumstances, users of electronic devices may use it to facilitate many types of tasks. For example, in the course of a work day, an employee may clock in to work, receive assignments, scan barcodes to determine inventory, upload scanned information, and clock out of work, all using an electronic device.

An embodiment of the invention allows a presenter to enable audience members to become more familiar with an electronic device, such as a mobile computer, smartphone, or tablet computer, and with the use of that device to facilitate various tasks. For example, audience members may be employees who need to be trained to use the electronic device. In an embodiment, audience members use the electronic device itself to learn how to use it. A presenter's device—a control node or control device 130—causes information regarding the use of the device to be transmitted to the electronic device 100, 101, 102, 110, 111, 112 for presentation to audience members. FIG. 1. The presenter's control device may be a device with a processor, a mobile device, a cell phone, a smart phone, a mobile computer, a laptop, a networked device, a desktop computer, a server computer, a display device, or a presentation device. The presenter uses the control device 130 to control what and when particular presentation content is displayed on the audience members' electronic devices. For example, the audience members' devices 110-112 may display a slide show demonstrating how to hold the device to collect bar code information from items on a shelf, thereby providing a better understanding of the process. FIG. 6. The control device 130 is also used to control what and when particular interactive content is performed on the audience members' devices 100-102. For example, the audience members' devices may simulate day-to-day activities, such as: the result of a barcode scan or an NFC (Near Field Communication) interaction; capturing an image, a video or a sound; presenting an image, a video, a sound, or a vibration. FIG. 7.

In another embodiment, audience members/employees may use one electronic device FIG. 6 to learn how to use another device FIG. 7, the device of interest. For example a presenter uses the control device 130, 510 to cause images, videos, and sounds to be presented to an audience member on a first device, such as a laptop computer, or a tablet. 501, FIG. 6. The presenter also uses the control device 510 to cause interactive content to be performed, at nearly the same time, on the second device 502, the device of interest. FIG. 7. For example, the second device may simulate day-to-day activities, such as the result of a barcode scan, by emitting a successful scan sound. In that way, the presenter uses the control device 510 to guide the audience member in learning to use the device of interest 502—by causing a presentation regarding the device of interest 502 to be displayed on the first device 501, and at nearly the same time, by causing the second device 502, the device of interest, to simulate day-to-day activities and behavior relevant to the content being displayed on the first device 501.

Some embodiments of the invention are directed to providing users of electronic devices information about using the devices to facilitate one or more tasks. The information is provided via a network to nodes on the network, and the network may be wireless. FIGS. 1 and 2. In one example, the nodes connected to a network are smartphone devices, and the information concerning using the devices to facilitate certain tasks is transmitted via the network to the devices. The transmitted information may cause the devices to present content in visual, audio, or other type of presentation mechanism, designed to communicate to the user various aspects of using the devices to facilitate certain tasks. FIG. 6. The transmitted information may also cause the devices to simulate functionality that the users might experience in the day-to-day use of the devices. FIG. 7. In some examples, the device may simulate ringing or receiving a SMS message; vibrate; or present a visual or audio message. FIG. 7. The presentation of the content and the simulation of device functionality are synchronized to enable the users of the device not only to be trained to use the device to facilitate certain tasks, but to also experience how the device would function in those tasks in day-to-day scenarios.

In some embodiments of the system, users may each employ two electronic devices (e.g., 100 and 110, or 501 and 502) at the same time, both being nodes connected to the network. FIGS. 1 and 5. For example, users may each have a tablet computer and a smartphone, where the smartphone is the device that will be used to facilitate certain tasks. FIGS. 1 and 5. In that example, the presentation of the content is performed by the tablet computer 501, 110 and the simulation of functionality occurs on the smartphone 502, 100. Because the content presentation and functionality simulation are synchronized, the immersive delivery of presentation elements enables users to learn about using the smartphone and simultaneously experience the smartphone's day-to-day device functionality. In some embodiments, another node on the network, such as a smartphone, tablet computer, laptop, or other electronic device, is a control node used to guide the audience through the presentation. In the embodiment of FIG. 3, a broadcast server serves as the control node, while in the embodiments of FIGS. 4 and 5, the broadcast server and the control node are two separate nodes. In any case, the control node may be used by a presenter to advance through each presentation element.

An embodiment of the system comprising a network 201 and network nodes 202 enables transmission of information between and among the network nodes 202 via the network 201. FIG. 2. In one embodiment, the network may comprise one or more wireless networks, such as Wi-Fi, 802.11a, 802.11b, 802.11g, and 802.11n. Wireless networks may comprise one or more wireless routers. FIG. 3. Each node 202, 302 is connected to the network 201, 301, and a node may be connected to the network via the wireless network. FIGS. 2 and 3. In one embodiment, some of the nodes may be audience devices 503, 504, and include mobile devices, such as tablet computers 501, smartphones 502, and mobile computers. FIG. 5. A presenter using the at least one node—a control node or control device 305,—may cause information to be transmitted via the network to audience devices being used by one or more audience members. In one example, a mobile device 501, 502 receiving the transmitted information may enable the audience member associated with the mobile device to experience presentation content via text, visual display, audio, vibration, or other presentation means that support the presenter in delivering the presentation. FIG. 6. The presentation content may be part of the transmitted information received by the mobile device; may, upon receiving the transmitted information, be separately retrieved or received by the mobile device from another node, a database node 530, and/or the mobile device's own memory; and may be a combination of any of the preceding.

Audience devices may have a processor and a memory, and may include a computer, a desktop computer, a thin client, a server computer, a presentation device, a display device, a gaming device, a networked device, a mobile phone, a mobile computer, a smart phone, a tablet computer, a laptop, a netbook, a personal digital assistant, and a mobile device. FIG. 1. Control nodes 130, 305, 405, 510 include a device with a processor, a mobile device, a cell phone, a smart phone, a mobile computer, a laptop, a networked device, a desktop computer, a server computer, a display device, or a presentation device. FIGS. 1, 3, 4, and 5. In one embodiment, the audience devices are in close proximity to the control node; and in other embodiments, one, more than one, or all of the audience devices are remotely located from the control node. The network may comprise a local area network, metropolitan area network, wide area network, the Internet, Wi-Fi, satellite-based, cellular network, PCS, 3G, 4G, LTE, and HSPA networks.

FIG. 7. In one embodiment, a mobile device, upon receiving the transmitted information, may perform an interaction. For example, the mobile device may simulate the day-to-day functionality of the mobile device, and the device may activate or deactivate a feature or function of the device. The mobile device may vibrate; simulate a barcode scan or a NFC (near field communications) interaction; capture an image, video, or sound; and/or present an image, video, or sound. According to one embodiment, upon receiving the transmitted information, a mobile device enables the user of the device to experience the presentation content and performs an interaction relevant to the presentation content. In an example of that embodiment, presentation content may be training to use an application on the mobile device, and the interaction may be a simulation of day-to-day functionalities of the device related to the content being presented. The system allows for such an immersive delivery of presentation elements by synchronizing the presentation contents and performance of device interactions. According to another embodiment, an audience member may use two audience devices, a first audience device 110, 501 for experiencing the presentation content, and a second audience 100, 502 device that performs interactions. FIGS. 1 and 5. The first audience device 501, upon receiving the transmitted information, enables the user of the first device to experience the presentation content. FIG. 6. The second audience device 502, upon receiving the transmitted information, performs an interaction, such as simulating a functionality of the second device. FIG. 7. The system allows for an immersive delivery of presentation elements by synchronizing the presentation content experience on the first audience device 501 with the simulation on the second audience device 502.

Although each audience member may be associated with both a first audience device and a second audience device, an embodiment of the system includes a first audience device and a second audience device together being associated with an audience of multiple members. In yet another aspect, in an audience of multiple members, the entire audience may be associated with—that is, share—one first audience device, while each audience member may be associated with his own second audience device. For example, the entire audience may share a device such as a tablet computer, mobile computer, or desktop computer that displays the presentation content in a large format, such as a large monitor or projector. Although the audience members share the device that plays the presentation content, each audience member continues to experience the immersive delivery of the training because each member may personally have a second audience device, the device that performs the interactive content. For example, the members of an audience may view a projection screen that describes the process of scanning barcodes to take inventory, while each member of the audience holds a device such as a smartphone or tablet computer that is simulating the device interactions as if it were being used in the process, e.g., scanning the barcodes. In another aspect, the entire audience may share more than one first audience device.

According to an embodiment, a control node 305 transmits the information to the audience devices 302. FIG. 3. The control node may obtain the information that it transmits from its own memory, a database node, or broadcast server node. A presenter uses the control node to guide the audience through the presentation. As the presenter advances through each element, the various audience devices respond accordingly—enabling a user of the device to experience the presentation content and/or performing an interaction. According to another embodiment, a method is provided for transmitting information to audience devices by a control node, wherein the transmitted information may be obtained by the control node from its own memory, a database node, or a broadcast server node. FIG. 10. The method may include guiding the audience through the presentation using the control node, and may further include audience devices responding accordingly—enabling a user of the device to experience the presentation content and/or a device performing an interaction.

According to some embodiments, a network node of the system is a broadcast server 406, 515 configured to transmit information to the audience devices. FIGS. 4 and 5. The broadcast server 406, 515 may obtain the information to transmit to the audience devices from its own memory, from a database node 530, or from a control node 405, 510. The broadcast server 515 may be configured to transmit identical information to each of the audience devices 501-504, and may be further configured to transmit such identical information substantially simultaneously. The broadcast server 515 thus broadcasts the information to the audience devices 501-504. FIGS. 5. For example, information, such as presentation content, may be broadcast by the broadcast server 406, 515 at substantially the same time to each of the audience devices 402, 501-504. A broadcast server 515 may transmit the information based on messages received from other nodes. In an example, a broadcast server 515 may transmit the information to the audience devices 501-504 upon receiving other information from a control node 510. That other information may include messages that cause the broadcast server 515 to transmit the information to the audience devices 501-504.

In one example, a broadcast server may be configured to receive other information from the audience devices. The content of the other information received by the broadcast server from the audience device may include messages indicating, for example, the status of such device; or questions from the user at the node or the user's answers to questions that were previously transmitted to such device. The broadcast server may be configured with a memory, and may store the other information it received in its memory. The broadcast server may be configured to transmit the other information it received to another network node, for example, a control node, for processing. According to another embodiment, the broadcast server, upon receiving the other information from an audience device, may retrieve yet further information. For example, a broadcast server, upon receiving information from the audience device, may retrieve yet further information from its memory, and transmit the yet further information to the audience device.

In one embodiment, a method is provided for transmitting information via a network to audience devices by a broadcast server. FIG. 8. The method may include transmitting identical information to each of the audience devices. The method may include transmitting information, identical or otherwise, to each device substantially simultaneously. The method thus includes broadcasting the information 800 to the audience devices. For example, the method includes broadcasting information, such as presentation content, by the broadcast server 800 at substantially the same time to each of the audience devices. The method may include receiving audience device information by the broadcast server from the audience devices 805, and based on the received audience device information, retrieving by the broadcast server of other information 815. For example, the received audience device information may cause the broadcast server to retrieve other information stored in its memory 815, and to transmit the retrieved other information to the audience device 820. The method includes optionally storing the audience device information received from the audience devices by the broadcast server in its memory 810.

In one embodiment, the method includes transmitting by the broadcast server the audience device information it received to another network node, for example, a control node, for processing 825. In another embodiment, an audience device may be configured to transmit audience device information via the network to a broadcast server 900. The audience device information may include messages indicating, for example, the status of the audience device. The messages may include questions from the audience member associated with the audience device or the audience member's answers to questions that were previously transmitted to the audience device. The broadcast server may be configured with a memory, and may store the received audience device information in its memory 905. The broadcast server may be configured to transmit the received audience device information to another network node, such as a control node, for processing 910. In one aspect, upon receiving audience device information from an audience node, the broadcast server may transmit presentation information to the audience node 915. Based on the transmitted presentation information, the audience devices may enable the users of the devices to experience the presentation content and/or a performance of a device interaction.

According to one embodiment, a method comprises providing network nodes which comprise audience devices. The method may include the audience device enabling the user of the device to experience presentation content 1105 upon receiving information from another network node, such as a control node or broadcast server 1100. The presentation content may be part of the received information; may include other content stored in the memory of the audience device; may be retrieved from another network node; and may be any combination of the foregoing. According to one aspect, the method includes the audience device performing device interactions, as described above. In some examples, the method further includes the audience device presenting a questionnaire. According to another aspect, the method may include an audience device transmitting audience device information via the network to a broadcast server 1110. The method further includes providing the broadcast server with a memory, and the broadcast server storing the received audience device information in the broadcast server's memory 1115.

According to an aspect, an audience device 302 may transmit audience device information to the control node 305, and the control node 305, in response to the audience device information, may transmit presentation information to the audience device 302. In another aspect, the control node 405, having received audience device information from an audience device 402, may transmit information to a broadcast server 406. The transmitted information may further comprise all or portions of the received audience device information. The broadcast server 406, having received the transmitted information from the control node 405, in turn transmits presentation information to the audience device 402. For example, an audience device 503 may transmit a message to the control device 510 indicating that the user of the device is ready for more content, and the control device 510 may, automatically or by the presenter's instruction, transmit a message to the broadcast server 515 to cause the broadcast server 515 to transmit the next element of the presentation to the audience device 503. In one aspect, the presentation information transmitted by the broadcast server 515 may further comprise all or a portion of the information that the broadcast server 515 received from the control node 530. In another aspect, the presentation information transmitted by the broadcast server 515 may further comprise all or a portion of the information already stored in the broadcast server's memory. In one example, the presentation information transmitted by the broadcast server 515 may further comprise all or a portion of information that the broadcast server 515 retrieves from another network node based on the information transmitted by the control node 510 to the broadcast server 515. In any case, having received the transmitted presentation information, an audience device 503 may enable the user of the device to experience the presentation content and/or the performance of device interaction.

According to another embodiment, a method comprises transmitting the information to audience devices by the control node 1100. The information transmitted by the control node to the audience devices may include messages to cause the audience devices to respond or react accordingly—to enable the user of the device to experience the presentation content and/or the performance of device interactions 1105. According to an aspect, the method may comprise the audience device transmitting audience device information to the control node 1120, and the control node, in response to the audience device information, transmitting presentation information to the audience device 1125. In another aspect, the method comprises the control node, after receiving audience device information from an audience device, transmitting information to the broadcast server 1130. The information transmitted by the control node to the broadcast server may comprise all or portions of the received audience device information. The method further comprises the broadcast server, after receiving the transmitted information from the control node, in turn transmitting presentation information to the audience device 1135. In one aspect of the method, the presentation information transmitted by the broadcast server may further comprise all or a portion of the information that the broadcast server received from the control node. In another aspect, the presentation information transmitted by the broadcast server may further comprise all or a portion of the information already stored in the broadcast server's memory. In one example, the presentation information transmitted by the broadcast server may further comprise all or a portion of information that the broadcast server retrieves from another network node. In any case, the method further comprises the audience device, after receiving the transmitted presentation information, enabling the user of the device to experience the presentation content and/or performance of device interactions.

According to another embodiment, the control node may be configured to transmit information to another network node, such as a broadcast server. FIG. 9. The broadcast server may have a memory, and may be configured to store the received information in the memory. The broadcast server may be configured to transmit, in turn, the information to the audience devices. FIG. 9. An audience device may be configured to transmit audience device information, which may include messages indicating the status of the audience node, to the broadcast server. FIG. 9. The messages may include questions from the audience member associated with such device or the member's answers to questions that were previously transmitted to such device. The broadcast server may be configured to receive the audience device information from the audience device, and may store the audience device information in its memory. FIG. 9. The broadcast server may transmit the audience device information it received to the control node. FIG. 9. The control node may be configured to process the audience device information received from the broadcast server, including status of one or more audience device, questions from audience members, and audience members' answers to questions previously transmitted to the audience devices.

In one embodiment, a control node may transmit information to a broadcast server, which may transmit, in turn, the information to a first audience device and a second audience device. FIG. 9. Based on the received information, the broadcast server may include other information in the information transmitted to the two audience devices. The other information may be in the broadcast server's memory or retrieved from another network node. FIG. 9. Based on the information and/or the other information it receives, the first audience device may enable the user of the device to experience presentation content, as described above. FIG. 9. The content may be part of the received information and/or the other information and may include content stored in the memory of the first audience node. According to one aspect, based on the received information and/or the other information, the second audience node may perform an interaction, as described above. FIG. 9. In another embodiment, a method comprises a control node transmitting information to a broadcast server, and the broadcast server in turn, transmitting the information to a first audience device and a second audience device. FIG. 10. The method may include the broadcast server, based on the received information, transmitting the other information together with the transmitted information to the two audience devices. The other information may be retrieved from the broadcast server's memory or from another network node. FIG. 10. The method includes the first audience device, based on the information and/the other information it receives, enabling the user of the device to experience presentation content, as described above. The content may be part of the received information and/or the other information, and may include content stored in the memory of the first audience node. FIG. 10. According to one aspect, the method includes the second audience device performing an interaction, as described above. FIG. 10.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above systems, constructions, devices, and methods without departing from the scope of aspects of the invention, it is intended that all matter contained in the above description and shown in the accompanying drawings shall be interpreted as illustrative and not in a limiting sense.

1. A system for transmission on network nodes, the system comprising:
a network; and
a plurality of network nodes, each node being connected to the network, including:
a control node configured to cause information to be transmitted via the network; and
an audience node configured to receive the information via the network.
